(19) United States
(12) Patent Application Publication
(10) Pub. No.: US 2014/0266048 A1
(43) Pub. Date: Sep. 18, 2014

(54) Dual Port Charger

(71) Applicant: BLACK & DECKER INC., Newark, DE (US)

(72) Inventors: Regina C. Cunanan, Baltimore, MD (US); Dustin M. Lee, Worthington, OH (US); Abhisheka Moturu, Pikesville, MD (US); Joel D. Sayles, Perry Hall, MD (US); Geoffrey S. Howard, Columbia, MD (US)

(73) Assignee: Black & Decker Inc., Newark, DE (US)

(21) Appl. No.: 13/835,290

(22) Filed: Mar. 15, 2013

(51) Int. Cl. H02J 7/00

(52) U.S. Cl. CPC H02J 7/0042
USPC 320/112

(57) ABSTRACT

A battery charger for charging a first battery pack and a second battery pack is disclosed. The charger includes a housing, a first and second charging circuit positioned within the housing, a first and second charging port coupled to the housing and electrically coupled the first and second charging circuits, respectively. The first charging port is configured to support the first battery pack and defines a first connection axis along which the first battery pack is movable to connect with the first charging circuit. The second charging port is configured to support the second battery pack and defines a second connection axis along which the second battery pack is movable to connect with the second charging circuit. The second charging port is configured to support the second battery pack while the first charging port supports the first battery pack.

### FIELD OF THE INVENTION

The present invention relates to battery chargers and, more particularly, to dual port chargers for supporting and charging more than one battery.

### SUMMARY

In one embodiment, the invention provides a battery charger for charging a first battery pack and a second battery pack. The battery charger includes a housing, a charging circuit positioned within the housing, and a first charging port coupled to the housing and electrically coupled to the charging circuit. The first charging port is configured to support the first battery pack. The first charging port defines a first connection axis along which the first battery pack is movable to connect with the charging circuit. The battery charger also includes a second charging port coupled to the housing and electrically coupled to the charging circuit. The second charging port is configured to support the second battery pack while the first charging port supports the first battery pack. The second charging port defines a second connection axis along which the second battery pack is movable to connect with the charging circuit. The first connection axis is angled relative to the second connection axis.

### BRIEF DESCRIPTION OF THE DRAWINGS

FIG. 1 is a front perspective view of a dual port charger.

FIG. 2 is a front perspective view of the dual port charger including two battery packs.

FIG. 3 is a side view of the dual port charger with two battery packs separated from the charger.

FIG. 4 is a top view of the dual port charger.

FIG. 5 is an exploded view of the dual port charge.

FIG. 6 is a block diagram of the dual port charger.

FIG. 7 is a top perspective view of the dual port charger.

FIG. 8 is a top perspective view of the dual port charger including one battery pack.

FIG. 9 is a front perspective view of the dual port charger including one battery pack.

FIG. 10 is a top perspective view of the dual port charger including two battery packs.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

FIGS. 1-10 illustrate a dual port charger 10 for charging two battery packs 14, 18 (FIGS. 2 and 3). As shown in FIGS. 2 and 3, the battery packs 14, 18 are two different styles or types of battery packs usable with portable equipment such as, for example, power tools. The first battery pack 14 is a slide-on style battery pack and may have a voltage ranging from 9 volts to 24 volts. The second battery pack 18 is a tower style battery pack and may have a voltage ranging from 9, volts to 24 volts. The first battery pack 14 may include ten batteries cells that can store about 55 Watt-hours of energy, and the second battery pack 18 may include six battery cells that can store about 35 Watt-hours of energy. In other embodiments, the battery packs 14, 18 may be compact battery packs having half the number of battery cells. In such embodiments, the first battery pack 14 may include five battery cells that can store about 27 Watt-hours of energy and the second battery pack 18 may include three battery cells 26 that can store about 17.5 Watt-hours of energy. In still other embodiments, the battery packs 14, 18 may include high energy cells capable of storing 33% more energy (e.g., about 72 Watt-hours and about 46 Watt-hours, respectively). In further embodiments, the first battery pack 14 and the second battery pack 18 may include any combination of cells. In addition, the charger 10 may support any combination of compact, standard, or high energy battery packs.

Referring back to FIGS. 1-10, the battery charger includes a housing 30, two charging ports 34, 38, and a two charging circuits 42a, 42b (FIG. 5). The housing 30 is generally composed of plastic and supports and/or encloses the other components of the battery charger 10. The illustrated housing 30 includes two top surfaces 46, 50 that are all angled (i.e., not parallel) relative to each other. The surfaces 46, 50 generally define separate planes such that each surface 46, 50 is a planar surface. The first surface 46 supplies the first charging port 34, while the second surface 50 supports the second charging port 38. The housing 30 is designed to support the charger 10 on a horizontal tabletop or hang the charger 10 from a vertical wall. When the charger 10 is supplied on a tabletop, the two surfaces 46, 50 represent the top of the charger 10. When the charger 10 is hung from a wall, a side surface 62 represents the top of the charger 10.

As shown in FIG. 1, the housing 30 defines a plurality of vents 66. Some of the vents 66A are positioned between the two surfaces 46, 50 of the housing 30 to help remove heat from the charger 10 that may collect at the highest point in the housing 30 when the charger 10 is supported on a tabletop. Other vents 66B extend on the side the side surface 62. The vents 66B extending onto the side surface 62 help remove heat from the charger 10 when the charger 10 is hanging from a wall.

As shown in FIG. 4, the housing 30 has a generally rectangular outer perimeter 70 that defines a footprint area of the charger 10. In the illustrated embodiment, the housing 30 has major dimensions (e.g., an overall length L, an overall width W, and an overall height H (FIG. 4)) of about 7 inches by about 9½ inches by about 3½ inches. In such embodiments, the footprint area is about 65 square-inches. In addition, the outer surfaces of the housing 30 define a volume of the charger 10 of about 300 cubic-inches. In other embodiments, the battery charger 10 may have major dimensions that are larger or smaller, may have a footprint area that is larger or smaller, may have a volume that is larger or smaller, and/or may have a different (e.g., non-rectangular) overall shape.

The charging ports 34, 38 are coupled to the housing 30 to support the battery packs 14, 18 on the charger 10 and to electrically couple the battery packs 14, 18 to the charging circuits 42a, 42b, respectively. The charging ports 34, 38 are configured to charge battery packs having different voltages, chemistries, and/or connecting structures. As shown in FIGS. 1 and 4, the first charging port 34 includes a connecting structure 74 having two spaced apart, parallel guide rails 78 and a terminal block 82. The guide rails 78 are integrally molded with the first surface 46 of the housing 30 and configured to engage corresponding guide rails 86 on the first battery pack 14 (FIG. 3). The terminal block 82 is electrically coupled to the charging circuit 42 (FIG. 5) to charge the first battery pack 14 when the battery pack 14 is connected to the charging port 34. The terminal block 82 can also communicate with the battery pack 14 to determine the presence of the battery pack 14, the voltage of the battery pack 14, and if the battery pack 14 is experiencing a fault.

As shown in FIGS. 1 and 4, the second charging port 38 includes a connecting structure 90 having a recess 94 and a terminal block 98. The recess 94 is formed in the second surface 50 of the housing 30 and configured to receive a stem portion 102 of the second battery pack 18 (FIG. 3). The terminal block 98 is electrically coupled to the charging circuit 42b (FIG. 5) to charge the second battery pack 18 when the battery pack 18 is connected to the charging port 38. The terminal block 98 can also communicate with the battery pack 18 to determine the presence of the battery pack 18, the voltage of the battery pack 18, and if the battery pack 18 is experiencing a fault.

As shown in FIGS. 1, 2, and 10 the first and second charging ports 34, 38 are positioned on the first and second surfaces 46, 50, respectively, of the housing 30 such that both battery packs 14, 18 maybe supported by the battery charger 10 at the same time. In addition, the charging ports 34, 38 are oriented such that the battery packs 14, 18 do not interfere, or otherwise contact each other, when the battery packs 14, 18 are being connected to or removed from the ports 34, 38. The first battery pack 14 slides onto the guide rails 78 of the first charging port 34 along a connection axis 106 that is generally parallel to the first surface 46 of the housing 30. The second battery pack 18 slides into the recess 94 of the second charging port 38 along a connection axis 110 that is close to, but slightly skewed from perpendicular to the second surface 50 of the housing 30. These connection axes 106, 110 are angled (i.e., not parallel) relative to each other due to the orientation of the surfaces 46, 50 and the configuration of the connecting structures 74, 90. As such, two non-parallel motions are required to connect the battery packs 14, 18 to the charger 10.

Due to the arrangement of the charging ports 34, 38 on the housing 30, the battery charger 10 can charge battery packs 14, 18 having a relatively high amount of energy in a relatively compact area or volume. For example, as noted above, the illustrated battery packs 14, 18 can store a combined amount of energy of between about 40 Watt-hours and about 120 Watt-hours. A ratio of this stored energy to the footprint area of the charger 10 (which is about 65 square-inches) is therefore between about 1.4 and about 1.8. In addition, a ratio of this stored energy to the volume of the charger 10 (which is about 300 cubic inches) is therefore between about 0.3 and about 0.4. In embodiments where the battery packs 14, 18 can store a combined amount of energy of about 90 Watt-hours, the ratio of stored energy to the footprint area is about 1.4, and the ratio of stored energy to the volume is about 0.3.

Furthermore, the illustrated battery packs 14, 18 include a combined total of twenty battery cells. A ratio of the total number of battery cells being supported by the charger 10 to the footprint area of the charger 10 is therefore about 0.3, but may be greater if the battery packs 14, 18 include 4P battery cells or may be less if the battery packs 14, 18 are compact packs having half the number of cells. A ratio of the total number of battery cells being supported by the charger 10 to the volume of the charger 10 is therefore about 0.07, but may be greater if the battery packs 14, 18 include 4P battery cells or may be less if the battery packs 14, 18 are compact packs having half the number of cells. In other embodiments, the battery packs 14, 18 may have higher voltages, higher energies, or more battery cells such that these ratios are even larger.

As shown in FIG. 5, the illustrated charging circuit 42 is a dual charging circuit positioned inside the housing 30. The charging circuit 42 includes two circuit boards 114a, 114b that is elevated by pedestals 118 within the housing 30 to facilitate cooling. The charging circuits 42a, 42b may charge both battery packs 14, 18 at the same time.

As shown in FIGS. 1 and 2, the battery charger 10 also includes two indicator lights 122, 126 associated with the charging ports 34, 38. The lights 122, 126 indicate the charge status of the battery packs 14, 18 connected to the ports 34, 38. In the illustrated embodiment, the battery charger 10 includes one indicator light 122, 126 associated with each charging port 34, 38. In other embodiments, the battery charger 10 may include more indicator lights associated with each charging port 34, 38. The illustrated indicator lights 122, 126 may include LEDs that are electrically coupled to the terminal blocks 82, 98 through the charging circuit 42. The indicator lights may include two LEDs may be associated with each port 34, 38. One of the LEDs may be one color (e.g., green), while the other LED associated with the same port 34, 38 may be a different color (e.g., red).

Each of the illustrated indicator lights 122, 126 may also includes a lens or light pipe. The lenses or light pipes may be composed of clear plastic material and coupled to the housing 30. The indicator lights 122, 126 are positioned in front of the charging ports 34, 38. Such a configuration facilitates viewing the LEDs when looking at the battery charger 10 from different orientations and when the charger 10 is hanging from a vertical wall.

While a battery pack is charging, the LEDs dedicated to the corresponding charging port 34, 38 illuminate to indicate what is going on. For example, a continuous red light indicates that the battery pack is charging, a continuous green light indicates that charging is complete, and blinking red and green lights indicate an error or fault with the battery pack.

FIG. 7 is a block diagram of the dual port charger 10. The battery charger 10 includes a battery pack control module or controller 158, a power control module 162, one or more power control safety modules 166, and a plurality of battery pack detection devices or charging port switches (not shown). The controller 158, the power control module 162, the power control safety modules 166, and the charging port switches work in conjunction with each other to control operation of the charger 10.

The controller 158 is configured to execute a charging control process using corresponding circuitry which determines, among other things, the type of charge required by a battery pack. The controller 158 also detects the presence of a battery pack in each charging port, selects an algorithm for charging, controls the power output from the power control module, and controls the illumination or display of the indicator lights 122, 126. The power control module 162 uses control signals from the controller 158 to control the charging current to the charging ports 34, 38. The power control safety modules 166 each include a power control safety or protection circuit that is configured to prevent the charging current and/or the charging voltage from damaging the battery charger 10 or a connected battery pack if the charging circuit malfunctions.

In some embodiments, one battery pack detection device is positioned within each charging port 34, 38 and is electrically connected to the controller 158. Each battery pack detection device includes a first conductive part that is coupled to a negative terminal of the power supply module, and a second conductive part that is coupled to the controller 158 and is powered at a control voltage.

The controller 158 may direct the power control module 162 to supply a charge to both of the battery packs 14, 18 inserted into the charging ports 34, 38 of the charger 10. For example, the controller 158 may enter a full charge mode for each battery pack 14, 18 or it may enter a float charge mode that directs the power control module 162 to provide a charging current to both of the inserted battery packs 14, 18. Once a given battery pack is fully charged, the controller 158 will direct the power control module 162 to stop supplying charging current to the fully charged battery pack. The controller 158 will then periodically check the status of the fully charged battery pack. If a drop in output voltage from the once fully charged battery pack is detected, the controller 158 will direct the power control module 162 to supply a charging current to the applicable charging port and to the battery pack until the battery pack is again fully charged.

In the illustrated embodiment, each charging port 34, 38 includes, or is operatively associated with, one of the battery protection circuitry or power control safety modules 166 to prevent damage to the battery packs 14, 18 and the battery charger 10 during a malfunction (e.g., a short circuit). In one embodiment of the power control safety modules 166, if one or more of the charging ports 34, 38 is malfunctioning, the circuitry of the power control safety module 166 protects the battery packs 14, 18 and the battery charger 10 from being damaged without rendering the remaining functional charging port inoperable. For example, the circuitry of the power control safety module 166 is configured to monitor the voltage of a predetermined node. If a voltage is detected at the node, a MOSFET is turned to the “on” state, and current flows through a control resistor. The control resistor is adjacent to and thermally coupled with a thermal fuse. A majority of the charging voltage is dissipated by the control resistor, which causes the control resistor to produce a substantial amount of heat in a short period of time. The heat generated by the control resistor is sufficient to open circuit (e.g., blow) the thermal fuse and prevent the charging current from reaching the battery pack.

The controller 158 is configured to identify defective charging ports and battery packs, and to provide an indication, such as a flashing LED, multiple flashing LEDs, or another indication device, to identify the charging port and/or the battery pack as defective. A defective charging port is identified by the controller 158, for example, when the power control module 162 is providing a charging current to a charging port which is not receiving a charging signal from the controller 158, or when a charging port that is receiving a charging signal from the controller 158 is not receiving a charging current from the power switching module 162 (e.g., when a fuse has opened). If, for example, a port FET is shorted, the controller 158 detects the shorted FET and disables the defective port to prevent a battery pack from being charged by the defective port. In some embodiments, the defective port signal continues as long as the battery charger 10 is powered. To reset the error condition, power must be removed from the charger 10 to reset the controller 158. Additionally or alternatively, in the instance of a defective battery pack, the battery charger 10 provides an indication via a flashing LED, multiple flashing LEDs, or another indication device, to a user. The error condition is then reset once the defective battery pack is removed.

The illustrated battery charger 10 may be configured to charge any of a plurality of different types of batteries or battery packs. For example, the battery charger 10 may be capable of charging battery packs having nickel-metal hydride (“NiMH”), nickel-cadmium (“NiCad”), lithium-cobalt (“Li—Co”), lithium-manganese (“Li-Ion”), Li—Mn spinel, or other suitable lithium or lithium-based chemistries. In some embodiments, the battery charger 10 may make a determination of the type of battery pack inserted into the charger based on, for example, a terminal voltage. In other embodiments, the charger 10 may receive information or a signal from a battery pack which indicates a battery pack type. In other embodiments, the ports 34, 38 may be structured to receive only compatible battery packs, and the battery charger 10 may merely detect the presence of an inserted pack.

The battery charger 10 may also be configured to receive and charge battery packs having any number of different voltage ratings, capacity ratings, configurations, shapes, and sizes. For example, the battery charger 10 may be operable to charge battery packs having voltage ratings of 4V, 8V, 12V, 14.4V, 16V, 18V, 20V, 24V, 48V, etc., or battery packs having any voltage rating therebetween. The battery charger 10 may also be operable to charge battery packs having individual cells with capacity ratings of 1.2 Ah, 1.3 Ah, 1.4 Ah, 2.0 Ah, 2.4 Ah, 2.6 Ah, 3.0 Ah, etc. The individual cell capacity ratings are combined to produce a total battery pack capacity rating, which is based both on the capacity ratings of the individual cells and the number of cells in each battery pack.

The configurations, shapes, and sizes of the battery packs include but are not limited to configurations, shapes, and sizes of battery packs that are attachable to and detachable from electrical devices such as power tools, test and measurement equipment, vacuum cleaners, outdoor power equipment, and vehicles. Power tools include, for example, drills, circular saws, jigsaws, band saws, reciprocating saws, screw drivers, angle grinders, straight grinders, hammers, impact wrenches, angle drills, inspection cameras, and the like. Test and measurement equipment includes, for example, digital multimeters, clamp meters, fork meters, wall scanners, IR temperature guns, and the like. Vacuum cleaners include, for example, stick vacuums, hand vacuums, upright vacuums, carpet cleaners, hard-surface cleaners, canister vacuums, broom vacuums, and the like. Outdoor power equipment includes blowers, chain saws, edgers, hedge trimmers, lawn mowers, trimmers, and the like. Vehicles include, for example, automobiles, motorcycles, scooters, bicycles, and the like.

Although the invention has been described with reference to certain preferred embodiments, variations and modifications exist within the scope and spirit of one or more independent aspects of the invention. For example, in further embodiments, the battery charger 10 may, be configured to simultaneously support three or more battery packs for charging.

Various features and advantages of the invention are set forth in the following claims.

1. A battery charger for charging a first battery pack and a second battery pack, the battery charger comprising:
a housing;
a charging circuit positioned within the housing;
a first charging port coupled to the housing and electrically coupled to the charging circuit, the first charging port configured to support the first battery pack, the first charging port defining a first connection axis along which the first battery pack is movable to connect with the charging circuit; and
a second charging port coupled to the housing and electrically coupled to the charging circuit, the second charging port configured to support the second battery pack while the first charging port supports the first battery pack, the second charging port defining a second connection axis along which the second battery pack is movable to connect with the charging circuit;
wherein the first connection axis is angled relative to the second connection axis.

2. The battery charger of claim 1, wherein the housing includes a first surface and a second surface that is spaced apart from the first surface, and wherein the first charging port is positioned on the first surface and the second charging port is positioned on the second surface such that the first and second battery packs do not interfere with each other when being connected to and removed from the first and second charging ports.

3. The battery charger of claim 2, wherein the first surface is angled relative to the second surface.

4. The battery charger of claim 3, wherein the first surface and the second surface connect together to form an apex of the housing, and wherein the housing defines a plurality of vents adjacent the apex.

5. The battery charger of claim 1, wherein the first charging port includes a first connecting structure and the second charging port includes a second connecting structure that is different than the first connecting structure.

6. The battery charger of claim 5, wherein the first connecting structure includes guide rails configured to engage corresponding guide rails of a slide-on style battery pack, and wherein the second connecting structure includes a recess configured to receive a portion of a tower style battery pack.

7. The battery charger of claim 1, wherein the first charging port is configured to support and charge a battery pack having a first voltage, and wherein the second charging port is configured to support and charge a battery pack having a second voltage that is different than the first voltage.

8. The battery charger of claim 7, wherein the first charging port is configured to support and charge an 18 volt battery pack, and wherein the second charging port is configured to support and charge a 12 volt battery pack.

9. The battery charger of claim 1, wherein the charging circuit is configured to charge the first and second battery packs in series.

10. The battery charger of claim 9, wherein the charging circuit is a single charging circuit positioned within the housing.
